(19) United States
(12) Patent Application Publication
(10) Pub. No.: US 2026/0254090 A1
(43) Pub. Date: Aug. 27, 2026

(54) METHOD FOR ADAPTING THE FREQUENCY RESPONSE OF A RADIO-FREQUENCY DEVICE

(71) Applicant: SWISSto12 SA, Renens (CH)

(72) Inventor: Mathieu Billod, Présilly (FR)

(21) Appl. No.: 19/162,729

(22) PCT Filed: Mar. 11, 2024
(86) PCT No.: PCT/IB2024/052331

§ 371 Date: Sep. 5, 2025

(30) Foreign Application Priority Data
Mar. 13, 2023 (CH) CH000277/2023

(51) Int. Cl. H01P 11/00; B22F 10/28; B22F 10/62; B22F 10/85; B33Y 10/00; B33Y 40/20; B33Y 50/02; B33Y 80/00

(52) U.S. Cl. CPC H01P 11/002; B22F 10/62; B22F 10/85; B33Y 40/20; B33Y 50/02; B33Y 80/00; B22F 10/28; B22F 2998/10; B33Y 10/00

(57) ABSTRACT

The present invention relates to a method of adapting the frequency response of a waveguide device obtained by additive manufacturing, the device comprising a semi-finished metal core including side walls having external and internal surfaces, the internal surfaces defining an internal opening of the device, comprising the steps of:
a. measuring a frequency response of the device to produce a first frequency response measurement;
b. chemically polishing the metal core by soaking to reduce a thickness of the sidewalls as a function of the first measurement and to increase a volume of the internal opening;
frequency response measurement;
   iterate steps a. to c. until the second measurement lies within a given range of values.

### TECHNICAL FIELD

The present invention concerns a method for adapting the frequency response of a radio-frequency device.

### BACKGROUND ART

Radio frequency (RF) signals can propagate either in space or in waveguide devices. These waveguide devices are used to channel RF signals or to manipulate them in the spatial or frequency domain.

The present invention relates in particular to passive RF devices that enable RF signals to be propagated and manipulated without the use of active electronic components. Passive waveguide devices can be divided into three distinct categories:
Devices based on waveguiding inside hollow metal channels, commonly referred to as waveguides.
Devices based on waveguiding inside dielectric substrates.
Devices based on wave guidance by means of surface waves on metal substrates such as PCBs, microstrips, etc.

The present invention relates in particular to the manufacture of waveguide devices according to the first category above, hereinafter collectively referred to as waveguide devices. Examples of such devices include waveguides as such, filters, antennas, polarizers, mode converters and so on. They can be used for signal routing, frequency filtering, signal separation or recombination, transmission or reception of signals into or from free space, etc.

Conventional waveguides are hollow devices whose shape and proportions determine the propagation characteristics for a given wavelength of the electromagnetic signal. Conventional waveguides used for radiofrequency signals have internal openings of rectangular or circular cross-section. They can propagate electromagnetic modes corresponding to different electromagnetic field distributions along their cross-section.

Manufacturing waveguides with complex cross-sections is difficult and costly. To remedy this, patent application US2012/0084968 proposes to produce waveguides by 3D printing. To this end, a non-conductive plastic core is printed using an additive method and then covered with a metal immersion plating. The internal surfaces of the waveguide must be electrically conductive in order to operate. The use of a non-conductive core not only reduces the weight and cost of the device, but also enables 3D printing methods suitable for polymers or ceramics to be used, making it possible to produce high-precision parts with low wall roughness. The parts described in this document have complex shapes and include, on the one hand, a channel for wave propagation and, on the other hand, holes for attachment to a foot of the waveguide, in order to secure it to another element.

Various 3D printing techniques exist, including selective laser melting (SLM) 3D printing. This is a selective powder-bed fusion process in which a laser is used to fuse fine metal particles. Following a computer-determined pattern, it melts the metal particles until they fuse together. A powder spreading system then applies a new layer of powder. The laser then draws the next layer. These steps follow one another until the object is fully printed.

Although SLM printing can print layer thicknesses ranging from 0.02 mm to 0.10 mm on the Z axis, resolution on the X and Y axes depends on the diameter of the machine's laser beam. Standard SLM machines use lasers with diameters of 0.080 mm and 0.1 mm. The molten pool around the laser beam for aluminum has a diameter of around 0.250 mm. Ideally, a minimum of 2 vectors is needed to produce a waveguide wall, hence a minimum thickness of 0.5 mm.

Depending on the desired shape, the metal parts obtained by this process can have layer thicknesses well beyond the Z resolution of the machine, which are imposed by the aforementioned constraints. This has a direct impact on the weight of the parts produced.

3D printing by selective laser sintering (SLS) is also well known, notably for plastic printing. It does, however, present the same problems of resolution, linked in particular to the diameter of the laser beam.

An important step in the manufacture of waveguide devices is the calibration of the device's frequency response to match its intended function.

In particular, the frequency response is determined by the geometry of the waveguide device's resonant cavity(ies), in particular the device's internal volume.

Adjustment screws inserted into the resonant cavity(ies) enable the frequency response of the device to be adapted from outside the device. This frequency response adaptation process takes place after the waveguide device itself has been manufactured, once the geometry of the device's resonant cavity can no longer be modified.

However, adapting the frequency response may require significant adjustments due to defects or imperfections in the manufacture of the device. These adjustments do not affect the geometry and internal volume of the device, but rather the external adjustment elements that need to be associated with the device.

There is therefore a need for a method of adapting the frequency response of a waveguide device, enabling this response to be adjusted during manufacture.

### BRIEF SUMMARY OF THE INVENTION

One aim of the present invention is to propose a method of adapting the frequency response of a waveguide device free from the limitations present in the prior art.

A further aim of the invention is to propose a faster method of adapting the frequency response of a waveguide device.

A further aim of the invention is to provide a method of adapting the frequency response of a waveguide device that limits the need for external components after the waveguide has been manufactured.

According to the present invention, these aims are achieved in particular by means of a method for adapting the frequency response of a waveguide device obtained by additive manufacturing, the device comprising a semi-finished metal core comprising side walls having external and internal surfaces, the internal surfaces defining an internal opening of the device, comprises the steps of:
a. measuring a frequency response of the device to produce a first frequency response measurement;
b. chemically polishing the metal core by soaking to reduce a thickness of the side walls as a function of the first measurement and to increase a volume of the internal opening;
c. measuring the frequency response of the device to produce a second frequency response measurement;
   iterating steps a. to c. until the second measurement lies within a given range of values.

In this way, the frequency response of the waveguide device is adapted by modifying the internal volume of the device.

In one embodiment, the soaking time is between 45 s and 90 s.

According to one embodiment, the thickness of the side walls is reduced by an ablation thickness of between 5 μm and 30 μm, preferably between 10 μm and 20 μm.

According to one embodiment, a final thickness of the device side walls after iteration of steps a. to c. is less than 300 μm, preferably less than 200 μm.

According to one embodiment, the metal core is produced by laser melting on a powder bed (SLM), in order to obtain a semi-finished metal core, said ablation thickness being equal to at least one time a powder grain size of said powder bed.

According to one embodiment, the semi-finished metal core soaking step is performed in an acid bath.

According to one embodiment, the acid bath comprises a mixture of two acids.

According to one embodiment, the acid bath comprises orthophosphoric acid and sulfuric acid.

According to one embodiment, the density of the bath is in a range between 1.5 g/cm³ and 2 g/cm³, preferably around 1.7 g/cm³.

In one embodiment, the acid bath treatment temperature is between 70° C. and 120° C.

According to one embodiment, the acid bath additionally comprises dissolved aluminum at a concentration of between 20 g/l and 50 g/l, preferably between 25 g/l and 45 g/l.

In one embodiment, the soaking of the semi-finished metal core is performed in a basic bath.

According to one embodiment, the basic bath comprises a caustic solution and having a pH greater than 11.5.

According to one embodiment, the process may comprise a step of:
b′. soaking the semi-finished metal core in an acid deoxidation bath following soaking in the basic bath, in order to remove oxidized residues from the surface of the device.

According to one embodiment, the process may comprise a step of:
b″. soaking the semi-finished metal core in an acid bath, for example a bath containing nitric acid and ammonium bi-fluoride, with a pH preferably below 2.

According to one embodiment, the process may comprise a step of
b′″. soaking the semi-finished metal core in a heated acid bath 10 with ultrasound application to clean it.

In particular, this solution has the advantage over the prior art of producing waveguide devices with a frequency response closer to that targeted, and requiring less adjustment and fine-tuning after manufacture.

In particular, the use of external elements such as adjustment screws for adjusting the frequency response can be largely limited or completely eliminated.

### EXAMPLE(S) OF EMBODIMENT OF THE INVENTION

Waveguide devices according to the present invention feature a metal core, for example made of aluminum, titanium, steel, invar or an alloy of these metals.

The core is manufactured by additive manufacturing, preferably by stereolithography, selective laser melting, selective laser sintering (SLS), binder jetting or direct energy deposition (DED). The wall thickness of the core is, for example, at least 0.5 mm.

This core delimits an internal opening forming a channel for wave guiding. The core therefore has an inner surface and an outer surface defining the inner opening, which is, for example, oblong in cross-section.

A chemical polishing bath works by leveling the microscopic surface roughness of the material, for example aluminum, used to form the core. Polishing is a process that reduces the roughness Ra of the material, enabling it to better reflect light (specularity). This is achieved by smoothing out the peaks and valleys (or hollows) on the surface of the material. Polishing is carried out by soaking the parts in a bath, under constant agitation.

The roughness Ra of the material, or average roughness or arithmetic mean roughness, refers to the average deviation between the peaks and valleys of the material on the scale of the particles (or grains) used for additive manufacturing.

Chemical or electrochemical polishing steps are known to reduce material roughness. Surprisingly, the polishing step of the present invention aims, in addition to improving the specularity of the material, to reduce the thickness of the walls of the waveguide device. Such a reduction in wall thickness also significantly reduces the weight of the device.

The frequency response of a waveguide device refers to the response of the device to a variable frequency input signal. This frequency response can be characterized by the amplitude of the device response, measured in decibels, and by the phase, measured in radians, as a function of frequency.

Measuring the frequency response of a waveguide device is essential to ensure correct operation of the device for the intended application.

In particular, frequency response depends on the geometry of the waveguide device, and more specifically on the internal geometry of the resonant cavities, notably their volume. A change in the internal volume of a waveguide device will modify its frequency response.

Generally speaking, measuring the frequency response of a given radio frequency device (or waveguide device) is done experimentally by propagating an input signal through the device and measuring the characteristics of the output signal, notably its amplitude and phase. Each type of radio-frequency device (RF device for short) has a frequency response (or more generally a range of frequency responses) that is optimal for its application. It is therefore advantageous to be able to adapt the frequency response of a manufactured device to a theoretical optimum frequency response value for that type of device.

The present method enables iterative adaptation of the frequency response of an RF device by successively polishing the device by soaking and measuring the frequency response after one or more soaks. This method can be used as an alternative to traditional frequency adaptation methods, or as a complement, as a fine-tuning step during the manufacturing process.

The various parameters relating to soaking, e.g. soaking time, number of soaks, bath composition, bath temperature, bath agitation during soaking, ultrasound application, etc., are thus determined as a function of the frequency response targeted for a given RF device. In particular, all these parameters vary according to the type of RF device and even from one device to another, depending on the intended application.

Thus, by way of example, one mode of execution of the present method comprises producing a first measurement of the frequency response of an RF device using known measurement techniques. Based on this first measurement, determining chemical polishing parameters as cited above and proceeding to chemically polish the device. As a result, the thickness of the device walls is reduced and the internal volume of the device is increased. A second measurement of the RF device's frequency response is then taken after polishing. If this second measurement corresponds to an amplitude and/or phase value in line with the device's intended application, the process stops. If the second measurement does not correspond to an amplitude and/or phase value in line with the device's intended application, a new set of chemical polishing parameters is determined on the basis of this second measurement, and the device is chemically polished again according to these new parameters. These steps are iterated until a measurement of the frequency response after polishing lies within a range of values corresponding to the device's desired application.

The terms “RF device” and “waveguide device” cover, in particular, the whole class of passive RF devices: single waveguides, waveguide arrays, antennas, antenna arrays, polarizers, in particular septum polarizers, combiners, dividers, transducers, in particular orthomode transducers, beamforming networks, filters, comb filters, evanescent mode filters.

The term “semi-finished metal core” refers to the state of the metal core obtained by additive manufacturing, but to which additional finishing steps still need to be applied. For example, chemical polishing steps as described above, but also coating, sanding, assembly steps, etc.

Advantageously, the thickness of the RF device side walls after the chemical polishing steps is less than 300 μm, preferably less than 200 μm, or even 150 μm. In this way, the chemical polishing steps make it possible not only to adapt the frequency response of the RF device, but also to obtain a wall thickness that is sufficient to limit the weight of the device.

In one embodiment, the ablation thickness, i.e. the thickness of the portion of material removed by chemical polishing at each stage, depends on the particular additive manufacturing technique used to produce the semi-finished core.

By way of example, when the semi-finished metal core is produced by laser melting on a powder bed, the ablation thickness is advantageously equal to at least one powder bed grain size. In this way, the surface finish after polishing is improved.

According to one embodiment, each polishing step comprises soaking the RF device in one or more successive baths. These baths may be of different or similar composition. The function of each bath may be to remove material, but also to clean or apply a surface treatment.

The soaking time in each of these baths may be different or similar. Typically, the soaking time in a bath is between 20 s and 200 s, depending on the desired ablation thickness and/or bath composition. Preferably, the soaking time is between 30 s and 120 s, or even between 45 s and 90 s.

The use of soaking baths to reduce the wall thickness of the waveguide device also makes it possible to combine the surface treatment steps (e.g. polishing to reduce internal roughness) required for proper device operation with the frequency response optimization steps. In fact, an additive manufacturing thickness for the walls of the semi-finished core can be determined according to the desired final surface state as well as according to the targeted frequency response. In this way, it is possible to optimize the manufacturing time, and therefore the cost, of the device since several steps can be carried out simultaneously.

1. A method of adapting the frequency response of a waveguide device obtained by additive manufacturing, the device comprising a semi-finished metal core comprising side walls having external and internal surfaces, the internal surfaces defining an internal opening of the device, comprising the steps of:
a. measuring a frequency response of the device to produce a first frequency response measurement ;
b. chemically polishing the metal core by soaking to reduce a thickness of the sidewalls as a function of the first measurement and to increase a volume of the internal opening;
c. measuring the frequency response of the device to produce a second frequency response measurement;
d. iterating steps a. to c. until the second measurement lies within a given range of values.

2. Method according to the preceding claim, wherein a soaking time is between 45 s and 90 s.

3. Method according to one of the preceding claims, wherein the thickness of the side walls is reduced by an ablation thickness of between 5 μm and 30 μm, preferably between 10 μm and 20 μm.

4. Method according to any one of the preceding claims, wherein a final thickness of the side walls of the device after iteration of steps a. to c. is less than 300 μm, preferably less than 200 μm.

5. Method according to one of the preceding claims, wherein the metal core is produced by laser melting on a powder bed (SLM), in order to obtain a semi-finished metal core, said ablation thickness being equal to at least one time a powder grain size of said powder bed.

6. Method according to any one of the preceding claims, wherein the step of soaking the semi-finished metal core is carried out in an acid bath.

7. Method according to claim 6, the acid bath comprising a mixture of two acids.

8. Method according to claim 7, the acid bath comprising orthophosphoric acid and sulfuric acid.

9. Method according to the preceding claim, wherein a bath density lies in a range between 1.5 g/cm³ and 2 g/cm³, preferably around 1.7 g/cm³.

10. Method according to any one of claims 6 to 9, wherein an acid bath treatment temperature lies between 70° C. and 120° C.

11. Method according to any one of claims 6 to 10, wherein the acid bath additionally comprises dissolved aluminum at a concentration of between 20 g/l and 50 g/l, preferably between 25 g/l and 45 g/l.

12. Method according to any one of claims 1 to 5, wherein the step of soaking the semi-finished metal core is carried out in an basic bath.

13. Method according to claim 12, wherein the basic bath comprises a caustic solution and having a pH greater than 11.5.

14. Method according to any one of claims 12 or 13, comprising a step of:
b′. soaking the semi-finished metal core in an acid deoxidation bath following soaking in the basic bath, in order to remove oxidized residues from the surface of the device.

15. Method according to one of claims 12 to 14, comprising a step of:
b″. soaking the semi-finished metal core in an acid bath, for example a bath containing nitric acid and ammonium bi-fluoride, with a pH preferably below 2.

16. Method according to one of claims 6 to 15, comprising a step of
b″′. soaking the semi-finished metal core in a heated acid bath 10 with application of ultrasounds for cleaning.
